(19) United States
(12) Patent Application Publication
(10) Pub. No.: US 2014/0292792 A1
(43) Pub. Date: Oct. 2, 2014

(54) Method for Applying Gamma Compensation To A Display And Gamma Compensation Device

(71) Applicants: Lixuan Chen, Shenzhen City (CN); Chih-tsung Kang, Shenzhen City (CN)

(72) Inventors: Lixuan Chen, Shenzhen City (CN); Chih-tsung Kang, Shenzhen City (CN)

(73) Assignee: Shenzhen China Star Optoelectronics Technology Co., Ltd., Shenzhen, Guangdong (CN)

(21) Appl. No.: 13/818,812

(22) PCT Filed: Jan. 28, 2013
(86) PCT No.: PCT/CN2013/071039

§ 371 Date: Feb. 25, 2013

(30) Foreign Application Priority Data
Jan. 23, 2013 (CN) 201310025188.0

(51) Int. Cl. G09G 5/10

(52) U.S. Cl. CPC G09G 5/10; G09G 2320/0673
USPC 345/589

(57) ABSTRACT

The present invention discloses a method for applying gamma compensation to a display and a gamma compensation device. The method comprises: respectively obtaining a brightness value when the display is displaying in a first environment, a brightness value of an ambient light reflected by a screen surface of the display in a second environment, wherein, the first environment is the environment that the display does not generate the ambient light reflected by the display; fitting to obtain a fitted gamma value according to the brightness value when the display is displaying in the first environment and the brightness value of the ambient light reflected by the screen surface of the display in the second environment; and adjusting a display brightness when the display is displaying according to the fitted gamma value. Through the above way, the present invention can increase the precise degree of the display in the environment having the ambient light, the sense of hierarchy and comfort.

### BACKGROUND OF THE INVENTION

1. Field of the Invention

The present invention relates to the field of display technology, and more particularly to a method for applying gamma compensation to a display and a gamma compensation device.

2. Description of Related Art

The gamma is a parameter of a display, and it is from the response curve of the display. The gamma represents a nonlinear relationship between the display brightness of the display and the input voltage. The same image may be displayed on the display with difference mainly depends on the magnitude of the gamma.

In the field of the display technology, the International Commission on Illumination (CIE) has developed a standard of gamma=2.2, but the gamma=2.2 is obtained by experiment when the display is placed in a darker environment without considering the bright environment such as lighting by lamps or a bright office environment. The display forms the brightness not only from emitting lights by itself but also reflecting the ambient light in a bright environment. Therefore, the fixed gamma value of 2.2 cannot meet the display effect in the bright environment such that it is easily to reduce the sense of hierarchy and comfort of the human eye.

### SUMMARY OF THE INVENTION

The technical problem solved by the present invention is to provide a method for applying gamma compensation to display and gamma compensation device such that it can increase the precise degree of the display in the environment having the ambient light in order to increase the sense of hierarchy and comfort of the sense of the human eye.

In order to solve the above-mentioned technical problem, a technical solution provided by the present invention is: a method for applying gamma compensation to a display, comprising: dividing a display brightness of the display into M brightness levels, obtaining brightness values of the display being set in each brightness level in a first environment and a brightness value of an ambient light reflected by a screen surface of the display in a second environment, wherein, the first environment is the environment that the display does not generate the ambient light reflected by the display, and M is an integer that is greater than one; fitting to obtain a fitted gamma value being closest to 2.2 according to the brightness value when the display is displaying in the first environment and the brightness value of the ambient light reflected by the screen surface of the display in the second environment; and adjusting a display brightness when the display is displaying according to the fitted gamma value.

Wherein, in the step of fitting to obtain a fitted gamma value according to the brightness value when the display is displaying in the first environment and the brightness value of the ambient light reflected by the screen surface of the display in the second environment, comprises: drawing a brightness curve of the display in the first environment according to the brightness values of each brightness level of the display in the first environment; and fitting by using a generalized least squares method to obtain the fitted gamma value according to the brightness curve of the display in the first environment and the brightness value of the ambient light reflected by the screen surface of the display in the second environment.

Wherein, in the step of adjusting display brightness when the display is displaying according to the fitted gamma value comprises: replacing a gamma value used by the display currently with the fitted gamma value in order to adjust the display brightness when the display is displaying.

In order to solve the above-mentioned technical problem, another technical solution provided by the present invention is: a method for applying gamma compensation to a display, comprising: respectively obtaining a brightness value when the display is displaying in a first environment, a brightness value of an ambient light reflected by a screen surface of the display in a second environment, wherein, the first environment is the environment that the display does not generate the ambient light reflected by the display; fitting to obtain a fitted gamma value according to the brightness value when the display is displaying in the first environment and the brightness value of the ambient light reflected by the screen surface of the display in the second environment; and adjusting a display brightness when the display is displaying according to the fitted gamma value.

Wherein, in the step of fitting to obtain a fitted gamma value according to the brightness value when the display is displaying in the first environment and the brightness value of the ambient light reflected by the screen surface of the display in the second environment, comprises: fitting to obtain the fitted gamma value being closest to 2.2 according to the brightness value when the display is displaying in the first environment and the brightness value of the ambient light reflected by the screen surface of the display in the second environment.

Wherein, in the step of respectively obtaining a brightness value when the display is displaying in a first environment, a brightness value of an ambient light reflected by a screen surface of the display in a second environment, wherein, the first environment is the environment that the display does not generate reflective light from the ambient light, comprises: dividing a display brightness of the display into M brightness levels, obtaining the brightness values of the display being set in each brightness level in the first environment, wherein M is an integer that is greater than one.

Wherein, in the step of fitting to obtain a fitted gamma value according to the brightness value when the display is displaying in the first environment and the brightness value of the ambient light reflected by the screen surface of the display in the second environment, comprises: drawing a brightness curve of the display in the first environment according to the brightness values of each brightness level of the display in the first environment; and fitting by using a generalized least squares method to obtain the fitted gamma value according to the brightness curve of the display in the first environment and the brightness value of the ambient light reflected by the screen surface of the display in the second environment.

Wherein, in the step of adjusting a brightness of the display when it is displaying according to the fitted gamma value comprises: replacing a gamma value used by the display currently with the fitted gamma value in order to adjust the display brightness when the display is displaying.

In order to solve the above-mentioned technical problem, another technical solution provided by the present invention is: a gamma compensation device comprising: an acquisition module for respectively obtaining a brightness value when a display is displaying in a first environment and a brightness value of an ambient light reflected by a screen surface of the display in a second environment, wherein, the first environment is the environment that the display does not generate the ambient light reflected by the display; a fitting module for fitting to obtain a fitted gamma value according to the brightness value when the display is displaying in the first environment and the brightness value of the ambient light reflected by the screen surface of the display in the second environment; and an adjusting module for adjusting a display brightness when the display is displaying according to the fitted gamma value.

Wherein, the fitting module is specifically for fitting to obtain a fitted gamma value closest to 2.2 according to the brightness value when the display is displaying in the first environment and the brightness value of the ambient light reflected by the screen surface of the display in the second environment.

Wherein, the acquisition module is specifically for dividing a display brightness of the display into M brightness levels, obtaining brightness values of the display being set in each brightness level in the first environment, wherein M is an integer that is greater than one.

Wherein, the fitting module comprises: a drawing unit for drawing a brightness curve of the display in the first environment according to the brightness values of each brightness level in the first environment; and a generalized least squares fitting unit for using a generalized least squares method to obtain a fitted gamma value according to the brightness curves of the display in the first environment and the brightness value of the ambient light reflected by the screen surface of the display in the second environment.

Wherein, the adjusting module is specifically for replacing a gamma value used by the display currently with the fitted gamma value in order to adjust display brightness when the display is displaying.

The beneficial effects of the present invention are: compared to the prior art, the present invention obtains a brightness value when a display is displaying in a first environment and a brightness value of an ambient light reflected by a screen surface of the display in a second environment, wherein, the first environment is the environment that is not affect by the ambient light, and the second environment is the environment that is affected by the ambient light. When the display is under the second environment, the brightness sensed by human eye when the display is displaying is the sum of the two brightness values. Then, fitting the two brightness values to obtain a fitted gamma value, and adjusting the display brightness when the display is displaying according to the fitted gamma value. The fitted gamma value is based on the sense of the human eye. Adjusting the display brightness of the display according to the fitted gamma value can increase the precise degree of the display in the environment having the ambient light, the sense of hierarchy and comfort.

### BRIEF DESCRIPTION OF THE DRAWINGS

FIG. 1 is a flowchart of a method for applying the gamma compensation to a display according to an embodiment of the present invention;

FIG. 2 is a flowchart of a method for applying the gamma compensation to a display according to another embodiment of the present invention;

FIG. 3 is a schematic diagram of a brightness curve corresponding to the brightness sensed by human eye and a brightness curve adjusted by the fitted gamma value when the display is placed in a second environment;

FIG. 4 is a schematic diagram of a gamma compensation device according to an embodiment of the present invention; and

FIG. 5 is a schematic diagram of a gamma compensation device according to another embodiment of the present invention.

### DETAILED DESCRIPTION OF THE PREFERRED EMBODIMENT

The following content combines with the drawings and the embodiment for describing the present invention in detail.

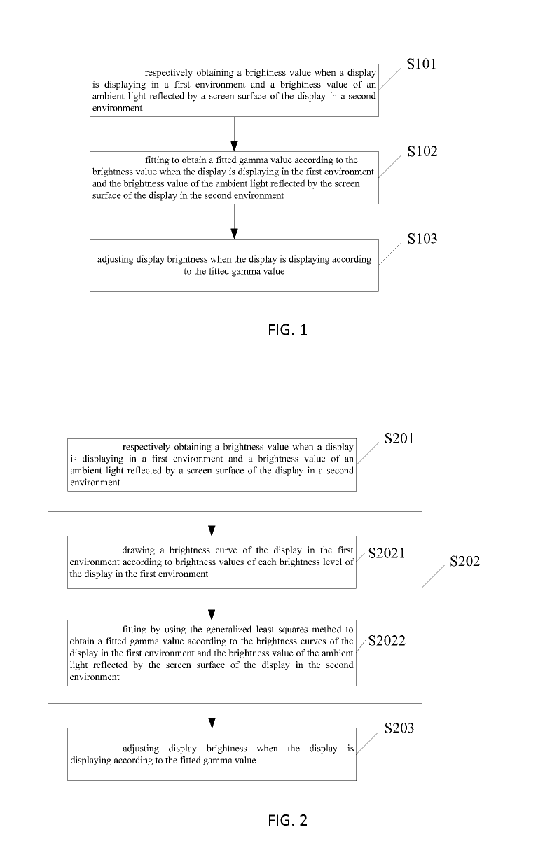

With reference to FIG. 1, it is a flowchart of a method for applying gamma compensation to a display according to an embodiment of the present invention, and the method comprising:

Step S101: respectively obtaining a brightness value when a display is displaying in a first environment and a brightness value of an ambient light reflected by a screen surface of the display in a second environment, wherein, the first environment are the environment that the display does not generate the ambient light reflected by the display;

In a bright environment, such as lighting by lamps or in a bright office environment, etc., the interaction of the reflected light between objects (such as a wall or a desk, etc.) and the emitting light from the light sources (e.g., illuminated lights, etc.) constitutes a sum of the lights, and the sum is referred to as the ambient light. In the present embodiment, the first environment is the environment that the display does not generate the ambient light reflected by the display such as a dark environment, and the second environment is the environment that the display can generate the ambient light reflected by the display such a bright environment;

In the dark environment, it obtains a brightness value when the display is displaying in that environment. In the bright environment, it obtains a brightness value of the ambient light reflected by a screen surface of the display. By that way, when the display is placed in the second environment, the brightness value sensed by the human eye when the display is displaying is the sum of the above two brightness values;

Wherein, it can use a testing method for obtaining the brightness value of the ambient light reflected by the screen surface of the display in the second environment such as a measuring method for the intensity of the reflected light of the screen surface of the display according to the visual basis, or an auxiliary equipment such as an ambient light sensor for obtaining the brightness value of the ambient light reflected by the screen surface of the display.

Wherein, the measuring method for the intensity of the reflected light of the screen surface of the display is specifically as follows:

In the bright environment, placing a first screen and a second screen in parallel, and the first screen is disposed with a shielding object for surrounding. It observes the display brightness in front of the two screens. When the display brightness of the two screens is observed to be the same, using instrument to obtain the brightness value of the first screen and the brightness value of the second screen such that it can calculate the intensity of the reflected light of the screen surface of the display according to the difference value of the brightness values of the first screen and the second screen.

Wherein, the first screen is surrounded with the shielding object to effectively block the ambient light for reducing or avoiding the impact the ambient light on the measurement, in order to obtain the display brightness of the first screen with no affecting of the ambient light or near no affecting of the ambient light.

Step S102: fitting to obtain a fitted gamma value according to the brightness value when the display is displaying in the first environment and the brightness value of the ambient light reflected by the screen surface of the display in the second environment;

The gamma value of a display ranges generally from 1.9 to 2.5. The greater gamma value, the greater the contrast ratio and the brightness value of the display. On the contrary, the smaller gamma value, the smaller contrast ratio and brightness value of the display;

In the second environment, because the display is affected by the ambient light during displaying, therefore, using the current gamma value of the display for displaying may not be applicable in current environment, and it easily leads to an uncomfortable feeling of the human eye. The present embodiment obtain a fitted gamma value according to the brightness value when the display is displaying in the first environment and the brightness value of the ambient light reflected by the screen surface of the display in the second environment.

Step S103: adjusting display brightness when the display is displaying according to the fitted gamma value;

In the second environment, adjusting the display brightness of the display when it is displaying according to the fitted gamma value such that the human eye feel more comfortable in viewing the display under the condition of reflecting the ambient light by the screen surface of the display.

Through the description of the foregoing embodiments, the present invention obtains a brightness value when a display is displaying in a first environment and a brightness value of the ambient light reflected by a screen surface of the display in a second environment, wherein, the first environment is the environment that is not affect by the ambient light, and the second environment is the environment that is affected by the ambient light. When the display is under the second environment, the display brightness sensed by human eye when the display is displaying is the sum of the two brightness values. Then, fitting the two brightness values to obtain a fitted gamma value, and adjusting the display brightness when the display is displaying according to the fitted gamma value. The fitted gamma value is based on the sense of the human eye. Adjusting the display brightness of the display according to the fitted gamma value can increase the sense of hierarchy and comfort.

With reference to FIG. 2, it is a flowchart of a method for applying the gamma compensation to a display according to another embodiment of the present invention, and the method comprises:

Step S201: respectively obtaining a brightness value when a display is displaying in a first environment and a brightness value of an ambient light reflected by a screen surface of the display in a second environment, wherein, the first environment is the environment that the display does not generate the ambient light reflected by the display such as a dark environment; the second environment is the environment that the display generates the ambient light reflected by the display, such as a bright environment;

In the dark environment, it obtains a brightness value when the display is displaying. In the bright environment, it obtains a brightness value of the ambient light reflected by the screen surface of the display. Specifically, the display brightness of the display can be divided into M levels, wherein M is an integer that greater than one and the level one is the darkest, the level M is the brightest. For example, the display brightness of the display is divided into 256 levels in accordance with the gray scale of the display, and obtaining brightness values of the display being set in each brightness level in the first environment.

Step S202: fitting to obtain a fitted gamma value according to the brightness value when the display is displaying in the first environment and the brightness value of the ambient light reflected by the screen surface of the display in the second environment;

In the step of fitting to obtain a fitted gamma value according to the brightness value when the display is displaying in the first environment and the brightness value of the ambient light reflected by the screen surface of the display in the second environment, the value of the fitted gamma is closest to 2.2.

Wherein, Step S202 includes the following sub-steps, and the specific content comprises:

Sub-step S2021: drawing a brightness curve of the display in the first environment according to brightness values of each brightness level of the display in the first environment;

In the first environment, it regulates and set each brightness level of the display and obtains the brightness values of each display brightness level. Specifically, it can contact closely with the display screen by using the brightness measurement instrument to measure and obtain the brightness values when the display is displaying. Drawing a brightness curve of the display using the divided brightness level as the horizontal coordinate and the brightness value as the vertical coordinate.

Sub-step S2022: fitting by using the generalized least squares method to obtain a fitted gamma value according to the brightness curves of the display in the first environment and the brightness value of the ambient light reflected by the screen surface of the display in the second environment;

The generalized least squares method also known as the least-squares method. It finds the best matched function for data by minimizing the sum of the square of the error. When the display is in the second environment, fitting by using the generalized least squares method to obtain a fitted gamma value according to the brightness curves of the display in the first environment and the brightness value of the ambient light reflected by the screen surface of the display in the second environment.

Step S203: adjusting display brightness when the display is displaying according to the fitted gamma value;

It adjusts the display brightness when the display is displaying according to the fitted gamma value. Specifically, in the second environment, it replaces a gamma value used by the display currently with the fitted gamma value in order to adjust the display brightness when the display is displaying. It can increase the sense of hierarchy and comfort of the human eye.

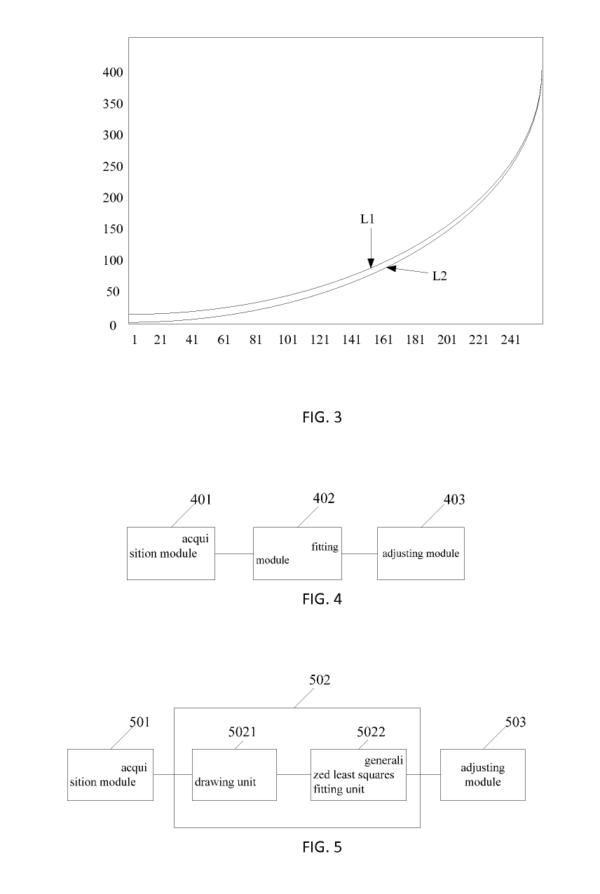

With reference to FIG. 3. FIG. 3 is a schematic diagram of a brightness curve corresponding to the brightness sensed by human eye and a brightness curve adjusted by the fitted gamma value when the display is placed in a second environment. As shown in FIG. 3, the display brightness level of the display is divided into 256 levels according to the gray scale of the display for example. The horizontal coordinate is the grayscale, and the vertical coordinate is the brightness value (nits in unit). The curve L1 is a brightness curve corresponding to the brightness value sensed by the human eye when the display is displaying in the second environment, and the curve L2 is a brightness curve adjusted by the fitted gamma value when the display is displaying.

As shown in FIG. 3, when the gray scale is 0, with reference to the curve L2, the brightness value is 0 when the display is displaying after adjusting by the fitted gamma value; with reference to the curves L1, in the second environment, the brightness value sensed by human eye is not 0, which is a result of the ambient light reflected by the screen surface of the display. Therefore, fitting by using the generalized least squares method to obtain a fitted gamma value according to the brightness curves of the display in the first environment and the brightness value of the ambient light reflected by the screen surface of the display in the second environment and adjusting the display brightness when the display is displaying according to the fitted gamma value. The difference is minimal between the brightness curve corresponding to the brightness sensed by human eye when the display is displaying in the second environment and the brightness curve after adjusting by the fitted gamma value when the display is displaying. Finally, it achieves increasing the sense of hierarchy and comfort of the human eye. Using the brightness of the ambient light reflected by the screen surface of the display being 10 nits as an example, the fitted gamma value is 2.334 after fitting, which is closest to 2.2.

With reference to FIG. 4, a gamma compensation device according to one embodiment of the present invention includes an acquisition module 401, a fitting module 402 and an adjusting module 403, wherein:

The acquisition module 401 is for respectively obtaining a brightness value when a display is displaying in a first environment and a brightness value of an ambient light reflected by a screen surface of the display in a second environment, wherein, the first environment are the environment that the display does not generate the ambient light reflected by the screen surface of the display;

The first environment is that the display does not generate the ambient light reflected by the screen surface of the display such as a dark environment. The second environment is that the display can generate the ambient light reflected by the screen surface of the display such as a bright environment.

The acquisition module 401 is specifically used in the dark environment to obtain the brightness value when the display is displaying in that environment, and in the bright environment, to obtain the brightness value of the ambient light reflected by the screen surface of the display in that environment. By that way, when the display is placed in the second environment, the brightness value sensed by the human eye when the display is displaying is the sum of the above two brightness values.

The fitting module 402 is used for fitting to obtain a fitted gamma value according to the brightness value when the display is displaying in the first environment and the brightness value of the ambient light reflected by the screen surface of the display in the second environment;

In the second environment, because the display is affected by the ambient light during displaying, therefore, using the current gamma value of the display for displaying may not be applicable in current environment, and it easily leads to an uncomfortable feeling of the human eye.

The fitting module 402 of the present embodiment is specifically fitting to obtain a fitted gamma value according to the brightness value when the display is displaying in the first environment and the brightness value of the ambient light reflected by the screen surface of the display in the second environment.

The adjustment module 403 is used for adjusting display brightness when the display is displaying according to the fitted gamma value;

The adjustment module 403 is specifically for adjusting the display brightness when the display is displaying according to the fitted gamma value such that the human eye feel more comfortable in viewing the display under the condition of reflecting the ambient light by the screen surface of the display.

With reference to FIG. 5, a gamma compensation device according to one embodiment of the present invention includes an acquisition module 501, a fitting module 502 and an adjusting module 503, wherein:

The acquisition module 501 is used is for respectively obtaining a brightness value when a display is displaying in a first environment and a brightness value of an ambient light reflected by a screen surface of the display in a second environment, wherein, the first environment are the environment that the display does not generate the ambient light reflected by the display;

The acquisition module 501 specifically used for dividing the display brightness of the display into M brightness levels, wherein M is an integer that greater than one, and the level one is the darkest, the level M is the brightest. For example, the display brightness of the display is divided into 256 levels in accordance with the gray scale of the display, and obtaining the brightness values of the display being set in each display brightness level in the first environment.

The fitting module 502 is used for fitting to obtain a fitted gamma value according to the brightness value when the display is displaying in the first environment and the brightness value of the ambient light reflected by the screen surface of the display in the second environment;

The fitting module 502 is specifically used for fitting to obtain the fitted gamma value according to the brightness value when the display is displaying in the first environment and the brightness value of the ambient light reflected by the screen surface of the display in the second environment, wherein, the value of the fitted gamma value is closest to 2.2.

Wherein, the fitting module 502 includes a drawing unit 5021, a generalized least squares fitting unit 5022.

The drawing unit 5021 is used for drawing a brightness curve of the display in the first environment according to the brightness values of each brightness level in the first environment;

The drawing unit 5021 is specifically used for regulating and setting each display brightness level in the first environment and obtaining a brightness value of the display under each display brightness level, and drawing the brightness curve of the display in the first environment.

The least-squares fitting unit 5022 is for using a least squares fitting method to fit a fitted gamma value according to the brightness curve of the display in the first environment and the brightness value of the ambient light reflected by the screen surface of the display in the second environment;

The generalized least squares fitting unit 5022 is specifically used for fitting by using the generalized least squares method to obtain a fitted gamma value according to the brightness curves of the display in the first environment and the brightness value of the ambient light reflected by the screen surface of the display in the second environment.

The adjustment module 503 is for adjusting display brightness when the display is displaying according to the fitted gamma value;

The adjustment module 503 is specifically used for replacing a gamma value used by the display currently with the fitted gamma value obtained above in order to adjust the display brightness when the display is displaying in the second environment. It can increase the sense of hierarchy and comfort of the human eye.

Through the description of the foregoing embodiments, the present invention obtains a brightness value when a display is displaying in a first environment and a brightness value of the ambient light reflected by a screen surface of the display in a second environment, wherein, the first environment is the environment that is not affect by the ambient light, and the second environment is the environment that is affected by the ambient light. When the display is under the second environment, the brightness sensed by human eye when the display is displaying is the sum of the two brightness values. Then, fitting the two brightness values to obtain a fitted gamma value, and adjusting the display brightness when the display is displaying according to the fitted gamma value. The fitted gamma value is based on the sense of the human eye. Adjusting the display brightness of the display according to the fitted gamma value can increase the sense of hierarchy and comfort.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A method for applying gamma compensation to a display, comprising:
dividing a display brightness of the display into M brightness levels, obtaining brightness values of the display being set in each brightness level in a first environment and a brightness value of an ambient light reflected by a screen surface of the display in a second environment, wherein, the first environment is the environment that the display does not generate the ambient light reflected by the display, and M is an integer that is greater than one;
fitting to obtain a fitted gamma value being closest to 2.2 according to the brightness value when the display is displaying in the first environment and the brightness value of the ambient light reflected by the screen surface of the display in the second environment; and
adjusting display brightness when the display is displaying according to the fitted gamma value.

2. The method according to claim 1, wherein, in the step of fitting to obtain a fitted gamma value according to the brightness value when the display is displaying in the first environment and the brightness value of the ambient light reflected by the screen surface of the display in the second environment, comprises:
drawing a brightness curve of the display in the first environment according to the brightness values of each brightness level of the display in the first environment; and
fitting by using a generalized least squares method to obtain the fitted gamma value according to the brightness curve of the display in the first environment and the brightness value of the ambient light reflected by the screen surface of the display in the second environment.

3. The method according to claim 1, wherein, in the step of adjusting display brightness when the display is displaying according to the fitted gamma value comprises:
replacing a gamma value used by the display currently with the fitted gamma value in order to adjust the display brightness when the display is displaying.

4. A method for applying gamma compensation to a display, comprising:
respectively obtaining a brightness value when the display is displaying in a first environment, a brightness value of an ambient light reflected by a screen surface of the display in a second environment, wherein, the first environment is the environment that the display does not generate the ambient light reflected by the display;
fitting to obtain a fitted gamma value according to the brightness value when the display is displaying in the first environment and the brightness value of the ambient light reflected by the screen surface of the display in the second environment; and
adjusting display brightness when the display is displaying according to the titled gamma value.

5. The method according to claim 4, wherein, in the step of fitting to obtain a fitted gamma value according to the brightness value when the display is displaying in the first environment and the brightness value of the ambient light reflected by the screen surface of the display in the second environment, comprises:
fitting to obtain the fitted gamma value being closest to 2.2 according to the brightness value when the display is displaying in the first environment and the brightness value of the ambient light reflected by the screen surface of the display in the second environment.

6. The method according to claim 4, wherein, in the step of respectively obtaining a brightness value when the display is displaying in a first environment, a brightness value of an ambient light reflected by a screen surface of the display in a second environment, wherein, the first environment is the environment that the display does not generate reflective light from the ambient light, comprises:
dividing a display brightness of the display into M brightness levels, obtaining the brightness values of the display being set in each brightness level in the first environment, wherein M is an integer that is greater than one.

7. The method according to claim 6, wherein, in the step of fitting to obtain a fitted gamma value according to the brightness value when the display is displaying in the first environment and the brightness value of the ambient light reflected by the screen surface of the display in the second environment, comprises:
drawing a brightness curve of the display in the first environment according to the brightness values of each brightness level of the display in the first environment; and
fitting by using a generalized least squares method to obtain the fitted gamma value according to the brightness curve of the display in the first environment and the brightness value of the ambient light reflected by the screen surface of the display in the second environment.

8. The method according to claim 4, wherein, in the step of adjusting a brightness of the display when it is displaying according to the fitted gamma value comprises:
replacing a gamma value used by the display currently with the fitted gamma value in order to adjust the display brightness when the display is displaying.

9. A gamma compensation device comprising:
an acquisition module for respectively obtaining a brightness value when a display is displaying in a first environment and a brightness value of an ambient light reflected by a screen surface of the display in a second environment, wherein, the first environment is the environment that the display does not generate the ambient light reflected by the display;
a fitting module for fitting to obtain a fitted gamma value according to the brightness value when the display is displaying in the first environment and the brightness value of the ambient light reflected by the screen surface of the display in the second environment; and
an adjusting module for adjusting display brightness when the display is displaying according to the fitted gamma value.

10. The device according to claim 9, wherein, the fitting module is specifically for fitting to obtain a fitted gamma value closest to 2.2 according to the brightness value when the display is displaying in the first environment and the brightness value of the ambient light reflected by the screen surface of the display in the second environment.

11. The device according to claim 9, wherein, the acquisition module is specifically for dividing a display brightness of the display into M brightness levels, obtaining brightness values of the display being set in each brightness level in the first environment, wherein M is an integer that is greater than one.

12. The device according to claim 11, wherein, the fitting module comprises:
a drawing unit for drawing a brightness curve of the display in the first environment according to the brightness values of each brightness level in the first environment; and
a generalized least squares fitting unit for using a generalized least squares method to obtain a fitted gamma value according to the brightness curves of the display in the first environment and the brightness value of the ambient light reflected by the screen surface of the display in the second environment.

13. The device according to claim 9, wherein, the adjusting module is specifically for replacing a gamma value used by the display currently with the fitted gamma value in order to adjust a display brightness when the display is displaying.
